(19) United States
(12) Patent Application Publication
(10) Pub. No.: US 2023/0303871 A1
(43) Pub. Date: Sep. 28, 2023

(54) Ink Jet Ink Composition, Ink Set, And Recording Method

(71) Applicant: SEIKO EPSON CORPORATION, Tokyo (JP)

(72) Inventor: Kunihiro FUJITA, Shiojiri (JP)

(21) Appl. No.: 18/126,516

(22) Filed: Mar. 27, 2023

(30) Foreign Application Priority Data
Mar. 28, 2022 (JP) 2022-051719

(51) Int. Cl. C09D 11/324; C09D 11/40; C09D 11/037; C09D 11/102; B41J 2/01

(52) U.S. Cl. CPC C09D 11/324; C09D 11/40; C09D 11/037; C09D 11/102; B41J 2/01

(57) ABSTRACT

An ink jet ink composition which is a water-based ink, includes a self-dispersible pigment, inorganic oxide particles, and a poly(ethylene glycol) represented by the following general formula (I), and the ink composition contains at least one type of metal ion selected from the group consisting of a potassium ion, a sodium ion, and a lithium ion.

HO—(CH₂—CH₂—O—)ₙ—H (I)

In the above formula, n represents an integer of 3 to 9.

The present application is based on, and claims priority from JP Application Serial Number 2022-051719, filed Mar. 28, 2022, the disclosure of which is hereby incorporated by reference herein in its entirety.

### BACKGROUND

### 1. Technical Field

The present disclosure relates to an ink jet ink composition, an ink set, and a recording method.

### 2. Related Art

Since being able to record a highly fine image by a relatively simple apparatus, an ink jet recording method has been rapidly developed in various fields. Among various recordings, in particular, in an ink jet recording to be performed on regular paper by a water-based ink using a high-speed continuous ink jet printer, a problem in that a stacking property is degraded by generation of curling is liable to occur. In order to suppress the generation of curling as described above, an ink jet ink composition containing inorganic oxide particles, such as silica particles, has been studied. For example, in order to provide an ink jet recording ink which is able to improve the stacking property, JP-A-2020-007444 has disclosed an ink jet recording ink containing a colloidal silica.

However, in an ink containing a self-dispersible pigment and inorganic oxide particles, a clogging recovery property is inferior.

### SUMMARY

According to an aspect of the present disclosure, there is provided an ink jet ink composition which is a water-based ink, comprising a self-dispersible pigment, inorganic oxide particles, and a poly(ethylene glycol) represented by the following general formula (I), and the ink jet ink composition described above contains at least one type of metal ion selected from the group consisting of a potassium ion, a sodium ion, and a lithium ion.

HO—(CH₂—CH₂—O—)ₙ—H (I)

In the formula, n represents an integer of 3 to 9.

According to another aspect of the present disclosure, there is provided an ink set comprising: a first ink composition which is the ink jet ink composition described above; and a second ink composition which is a water-based ink jet ink composition.

According to another aspect of the present disclosure, there is provided a recording method comprising: an ejection step of ejecting the ink jet ink composition described above from an ink jet head so as to be adhered to a recording medium.

### BRIEF DESCRIPTION OF THE DRAWING

FIG. 1s a view showing one example of a recording apparatus to be used for a recording method of this embodiment.

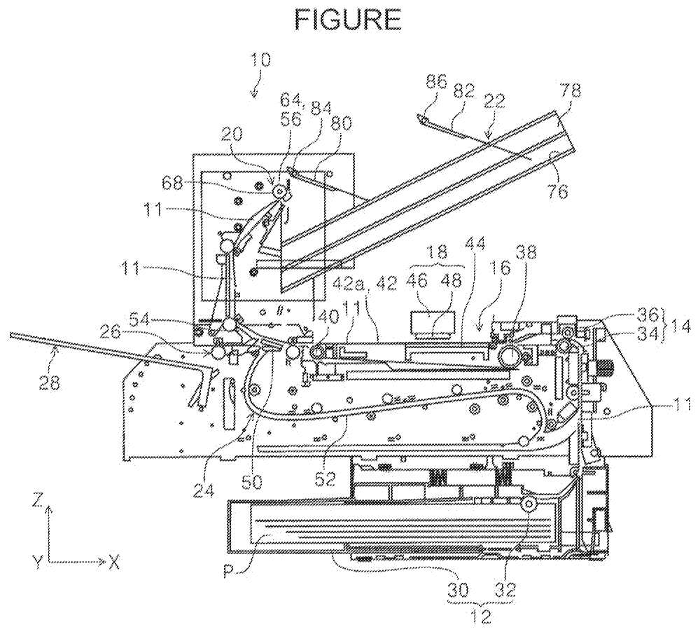

### DESCRIPTION OF EXEMPLARY EMBODIMENTS

Hereinafter, although an embodiment (hereinafter, referred to as “this embodiment”) of the present disclosure will be described in detail, if needed, with reference to the drawing, the present disclosure is not limited thereto and may be variously changed and/or modified without departing from the scope thereof. In addition, in the drawing, the same element is designated by the same reference numeral, and duplicated description will be omitted. In addition, unless otherwise particularly noted, the positional relationship, such as up to down and/or right to left, is based on the positional relationship shown in the drawing. Furthermore, the dimensional ratio in the drawing is not limited to that shown therein.

### 1. Ink Jet Ink Composition

An ink jet ink composition (hereinafter, simply referred to as “ink composition” in some cases) according to this embodiment is a water-based ink which includes a self-dispersible pigment, inorganic oxide particles, and a poly(ethylene glycol) represented by the following general formula (I) and which contains at least one type of metal ion selected from the group consisting of a potassium ion, a sodium ion, and a lithium ion. In addition, the ink jet ink composition of this embodiment may also contain at least one another component, if needed.

HO—(CH₂—CH₂—O—)ₙ—H (I)

In the above formula, n represents an integer of 3 to 9.

Heretofore, in an ink jet recording to be performed on regular paper by a water-based ink, a problem may occur such that the stacking property is liable to be degraded by the generation of curling. Accordingly, in order to suppress the generation of curling and to improve the stacking property, an ink jet ink composition containing inorganic oxide particles, such as silica particles, has been studied. The stacking property indicates whether or not, when many recording media after being recorded are discharged and stacked on a discharge tray of a printer, the edges of the recording media thus stacked can be finely aligned with each other. When a recording medium after being recorded is curled, the stacking property is degraded.

However, it has become understood that in the ink containing inorganic oxide particles as described above, in particular, when the pigment is a self-dispersible pigment, a foreign material is liable to be generated in the ink. Furthermore, by intensive research on the reason therefor carried out by the present inventor, the following was found. When inorganic oxide particles and a self-dispersible pigment are contained, and at least one type of metal ion selected from the group consisting of a potassium ion, a sodium ion, and a lithium ion is contained, a dispersion stability is destabilized, and a clogging recovery property is degraded. The metal ion may be an ion functioning as a counter ion of the inorganic oxide particles and/or the self-dispersible pigment.

In particular, when one ink composition contains inorganic oxide particles and a self-dispersible pigment and also contains at least two types of metal ions selected from the group consisting of a potassium ion, a sodium ion, and a lithium ion, the dispersion stability of the ink composition described above is destabilized, and the clogging recovery property is degraded. In particular, in the self-dispersible pigment and the inorganic oxide particles contained in the one ink composition, when a metal ion functioning as the counter ion of the self-dispersible pigment is different from a metal ion functioning as the counter ion of the inorganic oxide particles, at least two types of metal ions selected from the group consisting of a potassium ion, a sodium ion, and a lithium ion are contained in the one ink composition described above. Accordingly, those metal ions different from each other are mixed in the ink, and as a result, the dispersion stability is destabilized.

In addition, when one ink composition contains inorganic oxide particles and a self-dispersible pigment and also contains at least one type of metal ion selected from the group consisting of a potassium ion, a sodium ion, and a lithium ion, and when another ink composition to be used for recording together with the one ink composition described above contains a metal ion which is at least one selected from the group consisting of a potassium ion, a sodium ion, and a lithium ion and which is different from the metal ion contained in the one ink composition described above, the dispersion stability of the one ink composition described above is also destabilized, and the clogging recovery property and the ejection stability are degraded thereby. In the case described above, the metal ions each may also function as the counter ion of the self-dispersible pigment or the inorganic oxide particles contained in one of the inks described above in some cases.

In the cases described above, by the dispersion destabilization, the self-dispersible pigment and/or the inorganic oxide particles are aggregated to form coarse particles as a foreign material. In particular, it has become understood that when the dispersion of one of the self-dispersible pigment and the inorganic oxide particles is destabilized, the other is also involved in this destabilization to form a complex foreign material from the self-dispersible pigment and the inorganic oxide particles, and as a result, when the ink jet recording is performed, the clogging recovery property, an intermittent property, and the like are liable to be degraded.

Accordingly, since the ink jet ink composition of this embodiment contains the inorganic oxide particles, the stacking property is improved, and in addition, since the ink jet ink composition of this embodiment also contains the predetermined metal ion and the predetermined poly(ethylene glycol), the complex foreign material is suppressed from being generated from the self-dispersible pigment and the inorganic oxide particles, so that the clogging recovery property and the intermittent property can be improved.

The relationship between the poly(ethylene glycol) and the metal ion is not particularly limited, and for example, the present inventor considers that since a poly(ethylene glycol) having a predetermined molecular weight is coordinated to a predetermined metal ion, an interaction between the self-dispersible pigment and the metal ion to induce the formation of the complex foreign material is inactivated. In addition, an action mechanism to suppress the generation of the complex foreign material is not limited to that described above.

Hereinafter, components of the ink jet ink composition, an ink set, a recording method, and the like according to this embodiment will be described in detail.

### 1.1. Self-Dispersible Pigment

In this embodiment, the self-dispersible pigment is a pigment dispersible in a water-based medium without dispersants. As the self-dispersible pigment as described above, for example, a pigment in which a hydrophilic functional group or the like is directly introduced on a pigment surface by a physical and/or a chemical surface treatment may be mentioned. In addition, the self-dispersible pigment is discriminated from a resin dispersible pigment which is dispersed in a solvent using a dispersant.

Although a pigment to be used for the self-dispersible pigment as described above is not particularly limited, for example, there may be used an azo pigment (such as an azo lake, an insoluble azo pigment, a condensed azo pigment, or a chelate azo pigment); a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment); an organic pigment, such as a nitro pigment, a nitroso pigment, or an aniline black; an inorganic pigment, such as a carbon black (such as a furnace black, a thermal lamp black, an acetylene black, or a channel black), a metal oxide, a metal sulfide, or a metal chloride; or an extender pigment, such as silica, calcium carbonate, or talc. The pigment may be used alone, or at least two types thereof may be used in combination.

Among those mentioned above, at least one selected from the group consisting of the carbon black and the organic pigment is preferably contained. Accordingly, an image tends to be made more excellent. An ink containing at least one of those pigments may be used as a black ink or a chromatic ink. As the chromatic ink, for example, a cyan ink, a magenta ink, or a yellow ink may be mentioned. Furthermore, an orange ink, a red ink, or a blue ink may also be mentioned. The black is frequently used to record letters, and an ink having a high color development property is particularly useful.

In addition, as a method to perform a surface treatment on the pigment, a known method may be used, and although the known method as described above is not particularly limited, for example, there may be mentioned a method in which an ozone treatment is performed on a pigment surface or a method in which a hydrophilic functional group or the like is introduced on a pigment surface by an alkaline treatment, another chemical reaction, or the like. As the hydrophilic functional group to be introduced, for example, a carboxy group, a phosphoric group, or a sulfo group may be mentioned.

The self-dispersible pigment may contain, as the counter ion, at least one type of metal ion selected from the group consisting of a potassium ion, a sodium ion, and a lithium ion. Although a method to adjust the counter ion of the self-dispersible pigment is not particularly limited, for example, a method in which an alkali metal salt to be used when the self-dispersible pigment is prepared is adjusted may be mentioned.

In addition, a volume average particle diameter D₅₀ of the self-dispersible pigment is preferably 40 to 250 nm, more preferably 80 to 210 nm, further preferably 100 to 170 nm, and particularly preferably 110 to 150 nm. Since the volume average particle diameter is the above upper limit or less, the intermittent property and the clogging recovery property tend to be made more excellent, and since the volume average particle diameter is the above lower limit or more, the image tends to be made excellent.

The volume average particle diameter D₅₀ can be measured by a particle size distribution measurement device using a dynamic light scattering method as a measurement principle. As the particle size distribution measurement device as described above, for example, there may be mentioned a “zeta-potential/particle size/molecular weight measurement system ELSZ2000ZS” (trade name, manufactured by Otsuka Electronics Co., Ltd.) using a homodyne optical system as a frequency analysis method. In addition, in this specification, unless otherwise particularly noted, the “average particle diameter” indicates an average particle diameter based on the number of particles.

A content of the self-dispersible pigment with respect to a total mass of the ink jet ink composition is preferably 4.0 to 12 percent by mass, more preferably 6.0 to 10 percent by mass, and further preferably 6.0 to 8.0 percent by mass. Since the content of the self-dispersible pigment is 4.0 percent by mass or more, the image tends to be made excellent.

### 1.2. Inorganic Oxide Particles

Although the inorganic oxide particles are not particularly limited as long as capable of being dispersed in water, for example, there may be mentioned a metal oxide, such as silica, alumina, titania, zirconia, antimony oxide, tin oxide, tantalum oxide, zinc oxide, cerium oxide, lead oxide, or indium oxide; a metal nitride, such as silicon nitride, titanium nitride, or aluminum nitride; a metal carbide, such as silicon carbide or titanium carbide; a metal sulfide, such as zinc sulfide; a metal carbonate, such as calcium carbonate or magnesium carbonate; a metal sulfate, such as calcium sulfate or magnesium sulfate; a metal silicate, such as calcium silicate or magnesium silicate; a metal phosphate, such as calcium phosphate; a metal borate, such as aluminum borate or magnesium borate; or a complex compound of at least one of those mentioned above. The inorganic oxide particles may be particles forming a salt. In addition, the inorganic oxide particles may be used alone, or at least two types thereof may be used in combination. The inorganic oxide particles may be particles containing at least an inorganic oxide therein and are preferably particles formed from an inorganic oxide.

The inorganic oxide particles may contain, as the counter ion, at least one type of metal ion selected from the group consisting of a potassium ion, a sodium ion, and a lithium ion. Although a method to adjust the counter ion of the inorganic oxide particles is not particularly limited, for example, a method in which an alkali metal salt to be used when the inorganic oxide particles are prepared is adjusted may be mentioned.

In particular, at least one selected from the group consisting of silica, alumina, zirconia, titania, and ceria is preferably contained, and silica is more preferably contained. Accordingly, in an ink jet recording using a water-based ink jet ink composition, the generation of curling can be further suppressed, and the stacking property tends to be made excellent.

A volume average particle diameter D₅₀ of the inorganic oxide particles is preferably 100 nm or less, more preferably 5 to 90 nm, even more preferably 10 to 80 nm, further preferably 20 to 70 nm, even further preferably 30 to 80 nm, and particularly preferably 40 to 60 nm. Since the volume average particle diameter D₅₀ of the inorganic oxide particles is the upper limit described above or less, the intermittent property and the clogging recovery property tend to be made more excellent, and since the volume average particle diameter D₅₀ of the inorganic oxide particles is the lower limit described above or more, the image tends to be made more excellent. The measurement method of the volume average particle diameter is the same as described above.

A content of the inorganic oxide particles with respect to the total mass of the ink jet ink composition is preferably 0.5 to 8.0 percent by mass, more preferably 1.0 to 6.0 percent by mass, and further preferably 2.0 to 4.0 percent by mass. Since the content of the inorganic oxide particles is 0.5 percent by mass or more, the stacking property tends to be made excellent, and since the content of the inorganic oxide particles is 8.0 percent by mass or less, the clogging recovery property tends to be made excellent.

### 1.3. Metal Ion

The ink jet ink composition of this embodiment contains at least one type of metal ion selected from the group consisting of a potassium ion, a sodium ion, and a lithium ion. In addition, the metal ion preferably includes a metal ion derived from the counter ion of the self-dispersible pigment and/or the inorganic oxide particles.

In addition, in this embodiment, the counter ion indicates an ion to be electrically coupled when the self-dispersible pigment and/or the inorganic oxide particles form a salt. In addition, when the self-dispersible pigment and/or the inorganic oxide particles form a salt, the counter ion indicates an electrically coupled ion.

In addition, the ink jet ink composition of this embodiment may contain at least two types of metal ions selected from the group consisting of a potassium ion, a sodium ion, and a lithium ion. The at least two types of metal ions as described above preferably include a metal ion derived from the counter ion of the self-dispersible pigment described above and a metal ion which is different from the metal ion described above and which is derived from the counter ion of the inorganic oxide particles.

The metal ion is preferably a potassium ion since the image is made more excellent. In addition, a sodium ion or a lithium ion is preferable since the clogging recovery property or the like is made more excellent, and a sodium ion is more preferable.

Among those mentioned above, as the metal ions, a potassium ion derived from the counter ion of the self-dispersible pigment and at least one type of metal ion selected from the group consisting of a sodium ion derived from the counter ion of the inorganic oxide particles and a lithium ion derived from the counter ion of the inorganic oxide particles are more preferably contained, and as the metal ions, a potassium ion derived from the counter ion of the self-dispersible pigment and a sodium ion derived from the counter ion of the inorganic oxide particles are further preferably contained. Accordingly, the image and the clogging recovery property tend to be made excellent.

In addition, the ink jet ink composition according to this embodiment may also be an ink composition to be used for recording together with another ink jet ink composition which is a water-based ink. In the case described above, the another ink jet ink composition may be an ink composition containing at least one type of metal ion selected from the group consisting of a potassium ion, a sodium ion, and a lithium ion. Furthermore, in the case described above, the another ink jet ink composition may be an ink composition containing a metal ion which is at least one selected from the group consisting of a potassium ion, a sodium ion, and a lithium ion and which is different from the metal ion contained in the ink jet ink composition described above.

When at least two types of ink compositions containing different metal ions are used in combination and are configured to be ejected from nozzles of the same ink jet head, contact between the pigment inks ejected from adjacent nozzles, contact therebetween caused by flying ink mist, contact therebetween caused by wiping during cleaning, and/or the like may occur, and hence, the two types of ink compositions described above at least have an opportunity to be brought into contact with each other. By the contact as described above, when the ion contained in one of the two types of inks is mixed in the other ink, dispersion destruction may occur thereby in some cases, and for example, the complex foreign material may be unfavorably generated by the self-dispersible pigment and the inorganic oxide particles in some cases.

However, since the ink composition of this embodiment has the structure as described above, the complex foreign material is not likely to be generated, and the ink composition of this embodiment can be suitably used together with another ink composition containing a different metal ion. In particular, in the case in which the ink jet ink composition of this embodiment is used together with another ink composition, even when the contact between the pigment inks ejected from adjacent nozzles, the contact therebetween caused by flying ink mist, the contact therebetween caused by wiping during cleaning, and/or the like occurs, the complex foreign material is not likely to be generated, and the clogging recovery property and the intermittent property tend to be made excellent.

### 1.4. Poly(Ethylene Glycol)

The poly(ethylene glycol) of this embodiment is a poly(ethylene glycol) represented by the following general formula (I). In this embodiment, since the ink contains the poly(ethylene glycol) represented by the following general formula (I), the generation of the foreign material of the self-dispersible pigment and/or the inorganic oxide particles induced by the metal ion is suppressed, and the clogging recovery property and the intermittent property are made excellent. In addition, for example, the ejection stability is also made excellent.

In particular, as the poly(ethylene glycol) represented by the following general formula (I), since a poly(ethylene glycol) having a chain length corresponding to the ion radius is used, the present inventor considers that the ion can be appropriately enclosed, and hence, the generation of the complex foreign material can be suppressed; however, the reason for that is not limited thereto. The poly(ethylene glycol) of this embodiment may be used alone, or at least two types thereof may be used in combination.

HO—(CH₂—CH₂—O—)ₙ—H (I)

In the above formula, n represents an integer of 3 to 9.

When the metal ion of this embodiment includes a potassium ion, the n represents preferably an integer of 4 to 9, more preferably an integer of 5 to 9, and further preferably an integer of 6 to 8. Since the metal ion includes a potassium ion, the image tends to be made excellent. In addition, since the n is in the range described above, the poly(ethylene glycol) can suppress the generation of the complex foreign material derived from a potassium ion, and the clogging recovery property and the intermittent property tend to be made excellent.

When the metal ion of this embodiment includes a sodium ion, the n represents preferably an integer of 3 to 9, more preferably an integer of 3 to 7, and further preferably an integer of 4 to 6. Accordingly, the poly(ethylene glycol) can suppress the generation of the complex foreign material derived from a sodium ion, and the clogging recovery property and the intermittent property tend to be made excellent.

When the metal ion of this embodiment includes a lithium ion, the n represents preferably an integer of 3 to 9, more preferably an integer of 3 to 7, and further preferably an integer of 3 to 5.

A content of the poly(ethylene glycol) with respect to the total mass of the ink jet ink composition is preferably 0.5 to 10.0 percent by mass, more preferably 0.5 to 6.0 percent by mass, even more preferably 1.0 to 5.0 percent by mass, and further preferably 2.0 to 4.0 percent by mass. Since the content of the poly(ethylene glycol) is 0.5 percent by mass or more, the clogging recovery property tends to be made excellent, and since the content of the poly(ethylene glycol) is the above upper limit or less, the intermittent property tends to be made excellent.

A content of the poly(ethylene glycol) with respect to a total mass of the self-dispersible pigment and the inorganic oxide particles is preferably 5.0 to 75 percent by mass, more preferably 5.0 to 60 percent by mass, even more preferably 10 to 50 percent by mass, and further preferably 20 to 40 percent by mass.

### 1.5. Water-Soluble Fixing Resin

The ink jet ink composition of this embodiment preferably further contains a water-soluble fixing resin. The water-soluble fixing resin has a small amount of counter ions to be brought in the ink jet ink composition as compared to that of a resin emulsion or the like, the complex foreign material is not likely to be generated, and the clogging recovery property, the intermittent property, and the like tend to be made excellent.

The water-soluble fixing resin is a water-soluble resin and is also a fixing resin. Unlike a dispersion form of a resin emulsion or the like, the water-soluble resin is a resin in a dissolved state in water at ordinary temperature. In addition, unlike the dispersion form of a resin emulsion or the like, the water-soluble resin is a resin in a dissolved state in the ink. The fixing resin is a resin to enhance a fixing property of the ink to a recording medium.

Although the water-soluble fixing resin as described above is not particularly limited, for example, there may be mentioned an urethane-based resin, an acrylic-based resin, a fluorene-based resin, a polyolefin-based resin, a rosin-modified resin, a terpene-based resin, a polyester-based resin, a polyamide-based resin, an epoxy-based resin, a vinyl chloride-based resin, or an ethylene-vinyl acetate-based resin. Among those mentioned above, an urethane-based resin is preferable. The fixing resin may be used alone, or at least two types thereof may be used in combination.

A content of the water-soluble fixing resin with respect to the total mass of the ink jet ink composition is preferably 0.01 to 1.0 percent by mass, more preferably 0.05 to 0.5 percent by mass, even more preferably 0.02 to 0.3 percent by mass, further preferably 0.03 to 0.3 percent by mass, and particularly preferably 0.05 to 0.2 percent by mass. Since the content of the water-soluble fixing resin is 0.01 percent by mass or more, a line-marker resistance tends to be made excellent, and since the content of the water-soluble fixing resin is the above upper limit or less, the intermittent property tends to be made excellent.

### 1.6.1. Water

The ink composition of this embodiment is a water-based ink. The water-based ink is an ink containing water as a primary solvent component. A content of the water in the water-based ink with respect to the total mass of the ink is preferably 40 percent by mass or more, more preferably 45 to 98 percent by mass, even more preferably 50 to 80 percent by mass, and further preferably 65 to 75 percent by mass. When the ink is a water-based ink, since the inorganic oxide particles are contained, the stacking property can be made excellent.

### 1.6.2. Organic Solvent

Although the organic solvent in this embodiment is not particularly limited, for example, there may be mentioned a lower alcohol, such as methanol, ethanol, 1-propanol, isopropyl alcohol, 1-butanol, 2-butanol, isobutanol, or 2-methyl-2-propanol; a polyol, such as ethylene glycol, diethylene glycol, triethylene glycol, tetraethylene glycol, pentaethylene glycol, propylene glycol, dipropylene glycol, tripropylene glycol, or glycerin; or a glycol ether, such as triethylene glycol monomethyl ether, triethylene glycol dimethyl ether, triethylene glycol monobutyl ether, diethylene glycol monobutyl ether, or dipropylene glycol monopropyl ether. Among those mentioned above, a polyol is preferably contained, and glycerin is more preferably contained. The organic solvent may be used alone, or at least two types thereof may be used in combination.

A content of the organic solvent with respect to the total mass of the ink composition is preferably 5.0 to 25 percent by mass, more preferably 7.5 to 20 percent by mass, and further preferably 10 to 15 percent by mass.

### 1.7. Lactam-Based Compound

Although a lactam-based compound is not particularly limited as long as being an organic solvent or a solid compound at ordinary temperature, for example, there may be mentioned 2-pyrrolidone, N-methyl-2-pyrrolidone, N-hydroxyethyl-2-pyrrolidone, 3-methoxy-2-pyrrolidone, 3-acetoxy-2-pyrrolidone, 4-pentanelactam, or ε-caprolactam. Among those mentioned above, ε-caprolactam is preferable. Since the ink jet ink composition contains a lactam-based compound, the complex foreign material is not likely to be generated, and the clogging recovery property and the intermittent property tend to be made excellent.

A content of the lactam-based compound with respect to the total mass of the ink composition is preferably 1.0 to 8.0 percent by mass, more preferably 1.5 to 6.0 percent by mass, and further preferably 2.0 to 4.0 percent by mass. Since the content of the lactam-based compound is 1.0 percent by mass or more, the intermittent property tends to be made excellent. Among the lactam-based compounds, a liquid compound at ordinary temperature also functions as an organic solvent.

### 1.8. Surfactant

The ink composition of this embodiment may further contain a surfactant. Although the surfactant as described above is not particularly limited, for example, there may be mentioned an acetylene glycol-based surfactant, a silicone-based surfactant, or a fluorine-based surfactant. The surfactant may be used alone, or at least two types thereof may be used in combination.

The acetylene glycol-based surfactant is not particularly limited, and for example, there may be mentioned 2,4,7,9-tetramethyl-5-decyne-4,7-diol, an alkylene oxide adduct thereof, 2,4-dimethyl-5-decyne-4-ol, or an alkylene oxide adduct thereof is preferable.

Although the silicone-based surfactant is not particularly limited, for example, a polysiloxane-based compound or a polyether modified organosiloxane may be mentioned.

Although the fluorine-based surfactant is not particularly limited, for example, there may be mentioned a perfluoroalkyl sulfonate salt, a perfluoroalkyl carboxylate salt, a perfluoroalkyl phosphate ester, a perfluoroalkyl ethylene oxide adduct, a perfluoroalkyl alkyl betaine, or a perfluoroalkylamine oxide compound.

A content of the surfactant with respect to the total mass of the ink composition is preferably 0.1 to 2.0 percent by mass, more preferably 0.6 to 1.6 percent by mass, and further preferably 0.9 to 1.2 percent by mass.

### 1.9. Other Components

The ink jet ink composition of this embodiment may contain, besides the components described above, at least one of known components to be used for a related ink jet ink composition. Although the known components as described above are not particularly limited, for example, there may be mentioned additives such as a solubilizing agent, a viscosity adjuster, a pH adjuster, an antioxidant, an antiseptic agent, a fungicide, a corrosion inhibitor, and/or a chelating agent to trap metal ions influencing the dispersion; and an organic solvent other than the organic solvents described above.

### 2. Ink Set

An ink set of this embodiment is an ink set including a first ink composition which is the ink jet ink composition according to this embodiment and a second ink composition which is a water-based ink jet ink composition. In addition, in the ink set of this embodiment, as the first ink composition and/or the second ink composition, one or more ink compositions may be used. The ink set is a group formed of at least two ink compositions to be used for recording as a set. The ink compositions included in the ink set may be received in respective ink containers or may be received in respective chambers of an integrated ink container.

Not only in the case in which a metal ion functioning as a counter ion of a self-dispersible pigment contained in one pigment ink is different from a metal ion functioning as a counter ion of inorganic oxide particles contained therein, but also in the case in which at least two types of pigment inks to be used for recording as an ink set contain metal ions different from each other, by contact between the pigment inks ejected from adjacent nozzles, contact therebetween caused by flying ink mist, contact therebetween caused by wiping during cleaning, and the like, the complex foreign material is generated, and a long-term ejection stability may be degraded.

In addition, it becomes understood that in a flushing box, a cap, a waste liquid tank, and the like, since the metal ion functioning as the counter ion of the self-dispersible pigment and the metal ion functioning as the counter ion of the inorganic oxide particles, which are different from each other as described above, are mixed together, the complex foreign material is generated, and clogging is liable to occur in a waste liquid tank, a waste liquid path, and the like.

Accordingly, in this embodiment, since the ink jet ink composition included in the ink set contains the inorganic oxide particles, the stacking property is improved, and in addition, since the ink jet ink composition described above contains the predetermined metal ion and the predetermined poly(ethylene glycol), the complex foreign material of the self-dispersible pigment and the inorganic oxide particles is suppressed from being generated, so that an ink set excellent in clogging recovery property and intermittent property can be proved.

The second ink composition described above is not particularly limited as long as being a water-based pigment ink, and a related known pigment ink may be used.

In addition, the second ink composition may contain or may not contain the self-dispersible pigment, the inorganic oxide particles, the poly(ethylene glycol), the water-soluble fixing resin, the organic solvent, the lactam-based compound, the surfactant, and/or the other components of this embodiment.

The second ink composition may contain a metal ion which is at least one selected from the group consisting of a potassium ion, a sodium ion, and a lithium ion and which is different from the metal ion contained in the first ink composition. Even in the case described above, the ink set of this embodiment tends to be made excellent in long-term ejection stability.

The second ink composition may contain a self-dispersible pigment and/or inorganic oxide particles. In the case described above, a metal ion which is contained in the second ink composition, which is at least one selected from the group consisting of a potassium ion, a sodium ion, and a lithium ion, and which is different from the metal ion contained in the first ink composition may be a counter ion of the self-dispersible pigment or the inorganic oxide particles contained in the second ink composition. When the second ink composition contains a self-dispersible pigment and inorganic oxide particles, the second ink composition preferably contains the poly(ethylene glycol) described above.

### 3. Ink Jet Recording Method

An ink jet recording method according to this embodiment includes an ejection step of ejecting the ink jet ink composition described above from an ink jet head so as to be adhered to a recording medium. The ejection step may include sub-ejection steps of ejecting the respective ink compositions included in the ink set from an ink jet head so as to be adhered to a recording medium. The ink jet recording method may further include a transport step of transporting a recording medium. In addition, the ejection step and the transport step may be simultaneously or alternately performed.

### 3.1. Ejection Step

In the ejection step, the ink is ejected from the ink jet head and is then adhered to the recording medium. In more particular, a pressure generating device provided in the ink jet head is driven, and the ink filled in a pressure generating chamber in the ink jet head is ejected from a nozzle. The ejection method as described above is also called an ink jet method.

As the ink jet head used in the ejection step, a line head to perform recording by a line method and a serial head to perform recording by a serial method are mentioned.

In the line method using a line head, for example, an ink jet head having a width equal to or larger than a recording width of a recording medium is fixed in a recording apparatus. Subsequently, the recording medium is transferred in a sub-scanning direction (transport direction of the recording medium), and in conjunction with this transfer, ink droplets are ejected from the nozzle of the ink jet head, so that an image is recorded on the recording medium.

In the serial method using a serial head, for example, an ink jet head is mounted on a carriage movable in a width direction of a recording medium. Subsequently, the carriage is transferred along a main scanning direction (width direction of the recording medium), and in conjunction with this transfer, ink droplets are ejected from the nozzle of the ink jet head, so that an image is recorded on the recording medium.

### 3.2. Transport Step

The transport step transports the recording medium in a predetermined direction in the recording apparatus. In more particular, using a transport roller and/or a transport belt provided in the recording apparatus, the recording medium is transported from a paper feed portion to a paper discharge portion in the recording apparatus. In this transport step, the ink ejected from the ink jet head is adhered to the recording medium, so that a recorded matter is formed. The transport may be performed continuously or intermittently.

### 3.3. Recording Medium

A recording medium used in this embodiment is not particularly limited, and for example, an absorbing or a non-absorbing recording medium may be mentioned. Among those mentioned above, since an absorbing recording medium is liable to cause a problem, such as curling, the ink jet ink composition of this embodiment which can suppress the generation of curling by using the inorganic oxide particles and which is also excellent in clogging recovery property is effective.

Although the absorbing recording medium is not particularly limited, as examples thereof, there may be mentioned regular paper, such as electrophotographic paper, having a high permeability of an ink jet ink composition; ink jet paper (ink jet exclusive paper which includes an ink absorbing layer formed from silica particles or alumina particles or an ink absorbing layer formed from a hydrophilic polymer, such as a poly(vinyl alcohol) (PVA) or a poly(vinyl pyrrolidone) (PVP)); and art paper, coated paper, or cast paper which has a relatively low ink permeability and which is used for general offset printing.

Although the non-absorbing recording medium is not particularly limited, for example, there may be mentioned a film or a plate of a plastic, such as a poly(vinyl chloride), a polyethylene, a polypropylene, a poly(ethylene terephthalate) (PET), a polycarbonate, a polystyrene, or a polyurethane; a plate of a metal, such as iron, silver, copper, or aluminum; a metal plate or a plastic-made film formed by deposition of at least one of the various types of metals mentioned above; a plate of an alloy, such as stainless steel or brass; or a recording medium in which a film of a plastic, such as a poly(vinyl chloride), a polyethylene, a polypropylene, a poly(ethylene terephthalate) (PET), a polycarbonate, a polystyrene, or a polyurethane, is adhered (coated) on a paper-made substrate.

### 4. Ink Jet Recording Apparatus

A recording apparatus of this embodiment includes an ink jet head having at least one nozzle to eject an ink jet ink composition to a recording medium and a transport device to transport the recording medium. The ink jet head includes a pressure chamber to which the ink is supplied and the nozzle to eject the ink. In addition, the transport device is formed from a transport roller and/or a transport belt provided in the recording apparatus.

Hereinafter, one example of the recording apparatus according to this embodiment will be described with reference to FIGURE. In addition, in the X-Y-Z coordinate system shown in FIGURE, an X direction indicates a length direction of the recording medium, a Y direction indicates a width direction of the recording medium in a transport path in the recording apparatus, and a Z direction indicates a height direction of the apparatus.

As one example of a recording apparatus 10, a line type ink jet printer capable of performing printing at a high speed and at a high density will be described. The recording apparatus 10 includes a feed portion 12 to store a recording medium P such as paper, a transport portion 14, a belt transport portion 16, a record portion 18, an Fd (facedown) discharge portion 20 functioning as a “discharge portion”, an Fd (facedown) stage 22 functioning as a “stage”, a reverse path portion 24 functioning as a “reverse transport mechanism”, an Fu (faceup) discharge portion 26, and an Fu (faceup) stage 28.

The feed portion 12 is disposed at a lower side of the recording apparatus 10. The feed portion 12 includes a feed tray 30 to store the recording medium P and a feed roller 32 to feed the recording medium P stored in the feed tray 30 to a transport path 11.

The recording medium P stored in the feed tray 30 is fed to the transport portion 14 along the transport path 11 by the feed roller 32. The transport portion 14 includes a transport drive roller 34 and a transport driven roller 36. The transport drive roller 34 is rotationally driven by a driving source not shown. In the transport portion 14, the recording medium P is nipped between the transport drive roller 34 and the transport driven roller 36 and is then transported to the belt transport portion 16 located downstream of the transport path 11.

The belt transport portion 16 includes a first roller 38 located upstream of the transport path 11, a second roller 40 located downstream thereof, an endless belt 42 fitted to the first roller 38 and the second roller 40 in a rotationally transferable manner, and a support body 44 to support an upper-side section 42a of the endless belt 42 between the first roller 38 and the second roller 40.

The endless belt 42 is driven by the first roller 38 driven by the driving source not shown or the second roller 40 so as to be transferred from a +X direction to a −X direction in the upper-side section 42a. Hence, the recording medium P transported from the transport portion 14 is further transported downstream of the transport path 11 in the belt transport portion 16.

The record portion 18 includes a line type ink jet head 48 and a head holder 46 to hold the ink jet head 48. In addition, the record portion 18 may also be a serial type in which an ink jet head is mounted on a carriage which is reciprocally transferred in a Y axis direction. The ink jet head 48 is disposed so as to face the upper-side section 42a of the endless belt 42 supported by the support body 44. When the recording medium P is transported in the upper-side section 42a of the endless belt 42, the ink jet head 48 ejects the ink to the recording medium P, so that the recording is carried out. While the recording is carried out, the recording medium P is transported downstream of the transport path 11 by the belt transport portion 16.

In addition, the “line type ink jet head” is a head used for the recording apparatus in which a nozzle region formed in a direction intersecting the transport direction of the recording medium P is provided so as to cover the entire recording medium P in the intersecting direction, and while one of the head and the recording medium P is fixed, the other is transferred to form an image. In addition, the nozzle region of the line head in the intersecting direction may not cover the entire recording medium P in the intersecting direction in the recording apparatus.

In addition, a first branch portion 50 is provided downstream of the transport path 11 of the belt transport portion 16. The first branch portion 50 is configured to switchably communicate with one of the transport path 11 to transport the recording medium P to the Fd discharge portion 20 or the Fu discharge portion 26 and a reverse path 52 of the reverse path portion 24 in which after a recording surface of the recording medium P is reversed, the recording medium P is again transported to the record portion 18. In addition, the recording medium P to be transported after the transport path 11 is switched to the reverse path 52 by the first branch portion 50 is processed such that the recording surface thereof is reversed in a transport process in the reverse path 52 and is again transported to the record portion 18 so that a surface of the recording medium P opposite to the original recording surface faces the ink jet head 48.

In addition, a second branch portion 54 is further provided downstream of the first branch portion 50 along the transport path 11. The second branch portion 54 is configured so as to transport the recording medium P to one of the Fd discharge portion 20 and the Fu discharge portion 26 by switching the transport direction of the recording medium P.

The recording medium P transported to the Fd discharge portion 20 by the second branch portion 54 is discharged from the Fd discharge portion 20 and then placed on the Fd stage 22. In this case, the recording surface of the recording medium P is placed so as to face the Fd stage 22. In addition, the recording medium P transported to the Fu discharge portion 26 by the second branch portion 54 is discharged from the Fu discharge portion 26 and then placed on the Fu stage 28. In this case, the recording surface of the recording medium P is placed so as to face a side opposite to the Fu stage 28.

In addition, although the case in which the line type ink jet head is used has been described above by way of example, the recording apparatus of this embodiment may be a printer (serial printer) using a serial type ink jet head. In the serial printer, while a recording medium is transported in a transport direction, the ink jet head is transferred in a direction intersecting the transport direction described above, so that the printing is performed.

When the recording apparatus is a recording apparatus using a line type ink jet head, although the recording speed is preferably high, mist of the ink is liable to be generated from the nozzle of the ink jet head, and in order to obtain an excellent long-term ejection stability, this embodiment is particularly useful.

### EXAMPLES

Hereinafter, the present disclosure will be described in more detail with reference to Examples and Comparative Examples. However, the present disclosure is not limited at all to the following Examples.

### 1. Ink Jet Ink Composition

### 1.1. Preparation of Ink Jet Ink Composition

After components were charged in a mixing tank to have one of the compositions shown in Tables 1 to 2, filtration was performed using a 5-μm membrane filter, so that the ink jet ink composition of each example was obtained. In addition, unless otherwise particularly described, the numerical value of each component of each example shown in the table represents percent by mass. In addition, in the table, the numerical values of the self-dispersible pigment, the resin dispersible pigment, the inorganic oxide particles, the water-soluble fixing resin, and the lactam-based compound each represent percent by mass of a solid content.

TABLE 1

| | | METAL | EXAMPLE | | | | | | | | | | | |
|---|---|---|---|---|---|---|---|---|---|---|---|---|---|---|
| | | ION | INK 1 | INK 2 | INK 3 | INK 4 | INK 5 | INK 6 | INK 7 | INK 8 | INK 9 | INK 10 | INK 11 | INK 12 |
| SELF- | SELF-DISPERSIBLE PIGMENT 1 | K | 7 | 7 | 7 | 7 | 7 | | | | | | | |
| DISPERSIBLE | SELF-DISPERSIBLE PIGMENT 2 | Na | | | | | | 7 | 7 | 7 | | | | |
| PIGMENT | SELF-DISPERSIBLE PIGMENT 3 | Li | | | | | | | | | | 7 | 7 | 7 |
| | SELF-DISPERSIBLE PIGMENT 4 | Na | | | | | | | | | 7 | | | |
| RESIN | RESIN DISPERSIBLE PIGMENT | — | | | | | | | | | | | | |
| DISPERSIBLE | 1 | | | | | | | | | | | | | |
| PIGMENT | | | | | | | | | | | | | | |
| INORGANIC | COLLOIDAL SILICA 1 | Na | | | | 3 | | | | | | | | |
| OXIDE | (PARTICLE DIAMETER: 80 nm) | | | | | | | | | | | | | |
| PARTICLES | COLLOIDAL SILICA 2 | Na | 3 | 3 | 3 | | | 3 | 3 | 3 | 3 | 3 | 3 | 3 |
| | (PARTICLE DIAMETER: 45 nm) | | | | | | | | | | | | | |
| | COLLOIDAL SILICA 3 | Na | | | | | 3 | | | | | | | |
| | (PARTICLE DIAMETER: 11 nm) | | | | | | | | | | | | | |
| WATER- | WATER-SOLUBLE FIXING RESIN 1 | | 0.1 | 0.1 | 0.1 | 0.1 | 0.1 | 0.1 | 0.1 | 0.1 | 0.1 | 0.1 | 0.1 | 0.1 |
| SOLUBLE | | | | | | | | | | | | | | |
| FIXING RESIN | | | | | | | | | | | | | | |

| POLY | PEG1 (n = 4-9) | 3 | | | 3 | 3 | 3 | | | 3 | 3 | | |
|---|---|---|---|---|---|---|---|---|---|---|---|---|---|
| (ETHYLENE | PEG2 (n = 3-7) | | 3 | | | | | 3 | | | | 3 | |
| GLYCOL) | PEG3 (n = 3-5) | | | 3 | | | | | 3 | | | | 3 |
| | PEG4 (n = 2) | | | | | | | | | | | | |
| | PEG5 (n = 10-15) | | | | | | | | | | | | |
| LACTAM- | ε-CAPROLACTAM | 3 | 3 | 3 | 3 | 3 | 3 | 3 | 3 | 3 | 3 | 3 | 3 |
| BASED | | | | | | | | | | | | | |
| COMPOUND | | | | | | | | | | | | | |
| ORGANIC | GLYCERIN | 10 | 10 | 10 | 10 | 10 | 10 | 10 | 10 | 10 | 10 | 10 | 10 |
| SOLVENT | TRIETHYLENE GLYCOL | 3 | 3 | 3 | 3 | 3 | 3 | 3 | 3 | 3 | 3 | 3 | 3 |
| | MONOBUTYL ETHER | | | | | | | | | | | | |
| SUR- | ACETYLENE GLYCOL-BASED | 1 | 1 | 1 | 1 | 1 | 1 | 1 | 1 | 1 | 1 | 1 | 1 |
| FACTANT | SURFACTANT | | | | | | | | | | | | |
| WATER | | BALANCE | BALANCE | BALANCE | BALANCE | BALANCE | BALANCE | BALANCE | BALANCE | BAL- | BAL- | BAL- | BAL- |
| | | | | | | | | | | ANCE | ANCE | ANCE | ANCE |
| EVALUATION | CLOGGING RECOVERY PROPERTY | A | B | C | A | A | A | B | B | A | A | A | A |
| RESULT | INTERMITTENT PROPERTY | A | A | A | A | B | A | A | A | A | A | A | A |
| | STACKING PROPERTY | A | A | A | A | A | A | A | A | A | A | A | A |
| | IMAGE | A | A | A | B | A | B | B | B | B | B | B | B |
| | LINE-MARKER RESISTANCE | A | A | A | A | A | A | A | A | A | A | A | A |

TABLE 2

| | | | | | | | | | | | | | | | REFERENCE |
|---|---|---|---|---|---|---|---|---|---|---|---|---|---|---|---|
| | | METAL | EXAMPLE | | | | | | | | COMPARATIVE EXAMPLE | | | | EXAMPLE |
| | | ION | INK 13 | INK 14 | INK 15 | INK 16 | INK 17 | INK 18 | INK 19 | INK 20 | INK H1 | INK H2 | INK H3 | INK H4 | INK H5 |
| SELF- | SELF-DISPERSIBLE PIGMENT 1 | K | 7 | 7 | 5 | 7 | 7 | 7 | 7 | 7 | 7 | 7 | 7 | 7 | 7 |
| DISPERSIBLE | SELF-DISPERSIBLE PIGMENT 2 | Na | | | | | | | | | | | | | |
| PIGMENT | SELF-DISPERSIBLE PIGMENT 3 | Li | | | | | | | | | | | | | |
| | SELF-DISPERSIBLE PIGMENT 4 | Na | | | | | | | | | | | | | |
| RESIN | RESIN DISPERSIBLE PIGMENT | — | | | | | | | | | | | | | 7 |
| DISPERSIBLE | 1 | | | | | | | | | | | | | | |
| PIGMENT | | | | | | | | | | | | | | | |
| INORGANIC | COLLOIDAL SILICA 1 | Na | | | | | | | | | | | | | |
| OXIDE | (PARTICLE DIAMETER: 80 nm) | | | | | | | | | | | | | | |
| PARTICLES | COLLOIDAL SILICA 2 | Na | 3 | 3 | 3 | 7 | 1 | 3 | 3 | 3 | 3 | | 3 | 3 | 3 |
| | (PARTICLE DIAMETER: 45 nm) | | | | | | | | | | | | | | |
| | COLLOIDAL SILICA 3 | Na | | | | | | | | | | | | | |
| | (PARTICLE DIAMETER: 11 nm) | | | | | | | | | | | | | | |

| WATER- | WATER-SOLUBLE FIXING RESIN 1 | 0.1 | 0.1 | 0.1 | 0.1 | 0.1 | 0.3 | | 0.1 | 0.1 | 0.1 | 0.1 | 0.1 | 0.1 |
|---|---|---|---|---|---|---|---|---|---|---|---|---|---|---|
| SOLUBLE | | | | | | | | | | | | | | |
| FIXING RESIN | | | | | | | | | | | | | | |
| POLY | PEG1 (n = 4-9) | 1 | 5 | 3 | 3 | 3 | 3 | 3 | 3 | | 3 | | | |
| (ETHYLENE | PEG2 (n = 3-7) | | | | | | | | | | | | | |
| GLYCOL) | PEG3 (n = 3-5) | | | | | | | | | | | | | |
| | PEG4 (n = 2) | | | | | | | | | | | 3 | | |
| | PEG5 (n = 10-15) | | | | | | | | | | | | 3 | |
| LACTAM- | ε-CAPROLACTAM | 3 | 3 | 3 | 3 | 3 | 3 | 3 | | 3 | 3 | 3 | 3 | 3 |
| BASED | | | | | | | | | | | | | | |
| COMPOUND | | | | | | | | | | | | | | |
| ORGANIC | GLYCERIN | 10 | 10 | 10 | 10 | 10 | 10 | 10 | 10 | 10 | 10 | 10 | 10 | 10 |
| SOLVENT | TRIETHYLENE GLYCOL | 3 | 3 | 3 | 3 | 3 | 3 | 3 | 3 | 3 | 3 | 3 | 3 | 3 |
| | MONOBUTYL ETHER | | | | | | | | | | | | | |
| SURFACTANT | ACETYLENE GLYCOL-BASED | 1 | 1 | 1 | 1 | 1 | 1 | 1 | 1 | 1 | 1 | 1 | 1 | 1 |
| | SURFACTANT | | | | | | | | | | | | | |
| WATER | | BALANCE | BALANCE | BALANCE | BALANCE | BAL- | BAL- | BAL- | BAL- | BAL- | BAL- | BAL- | BAL- | BAL- |
| | | | | | | ANCE | ANCE | ANCE | ANCE | ANCE | ANCE | ANCE | ANCE | ANCE |
| EVALUATION | CLOGGING RECOVERY PROPERTY | B | A | A | C | A | A | A | A | D | A | D | D | B |
| RESULT | INTERMITTENT PROPERTY | A | C | A | B | A | C | A | C | C | A | A | B | B |
| | STACKING PROPERTY | A | A | A | A | B | A | A | A | A | C | A | A | A |
| | IMAGE | A | A | C | A | B | A | A | A | A | A | A | A | B |
| | LINE-MARKER RESISTANCE | A | A | A | A | A | A | C | A | A | A | A | A | A |

The abbreviations and the details of the product components used in Tables 1 and 2 are as shown below.

### Self-Dispersible Pigment

Self-dispersible pigment 1: prepared as described below.

After a carbon black was processed by a pulverization treatment and then mixed with water, this mixture solution was processed by an ozone treatment. The ozone treatment was performed at an ozone concentration of the mixture solution of 5.5 to 6.0 percent by weight for 6 hours. After the treatment, potassium hydroxide was added to this mixture solution. A pulverization treatment was further performed.

A self-dispersible carbon black pigment having a volume average particle diameter D₅₀ of 110 nm and containing potassium as a counter ion was obtained.
Self-dispersible pigment 2: prepared as described below.

In the preparation of the self-dispersible pigment 1, in a manner similar to that described above except for that sodium hydroxide was used instead of using potassium hydroxide, a self-dispersible carbon black pigment having a volume average particle diameter D₅₀ of 110 nm and containing sodium as a counter ion was obtained.
Self-dispersible pigment 3: prepared as described below.

In the preparation of the self-dispersible pigment 1, in a manner similar to that described above except for that lithium hydroxide was used instead of using potassium hydroxide, a self-dispersible carbon black pigment having a volume average particle diameter D₅₀ of 110 nm and containing lithium as a counter ion was obtained.
Self-dispersible pigment 4: “Cabojet250C” manufactured by Cabot Japan K.K., a self-dispersible copper phthalocyanine pigment containing sodium as a counter ion.

### Resin Dispersible Pigment

Resin dispersible pigment 1: prepared as described below.

After a carbon black powder was pulverized and then mixed in water, with a styrene-acrylic-based dispersant resin (“YS-1274” manufactured by Seiko PMC Corporation) at a mass ratio of 3:1, stirring was performed using a bead mill, so that a resin dispersible pigment was obtained. The volume average particle diameter thereof was 110 nm.

### Inorganic Oxide Particles

Colloidal silica 1 (particle diameter: 80 nm): “Cataloid SI-80P” manufactured by JGC Catalysts and Chemicals Ltd.
Colloidal silica 2 (particle diameter: 45 nm): “Cataloid SI-45” manufactured by JGC Catalysts and Chemicals Ltd.
Colloidal silica 3 (particle diameter: 11 nm): “Cataloid SI-30” manufactured by JGC Catalysts and Chemicals Ltd., each of which was a colloidal silica containing sodium as a counter ion.

### Water-Soluble Fixing Resin

Water-soluble fixing resin 1: prepared as described below.

A four-necked flask equipped with a stirrer, a thermometer, a nitrogen gas inlet tube, and a reflux tube was prepared. In this four-necked flask, 41.7 parts by mass of isophorone diisocyanate, 40.1 parts by mass of a poly(propylene glycol) (number average molecular weight: 2,000), 13.2 parts by mass of dimethylol propionic acid, and 200.0 parts by mass of methyl ethyl ketone were charged, and a reaction was performed at 80° C. for 6 hours in a nitrogen gas atmosphere. Subsequently, 0.6 parts by mass of ethylene diamine, 2.0 parts by mass of methanol, 2.4 parts by mass of dimethylol propionic acid, and 100.0 parts by mass of methyl ethyl ketone were added. While a remaining rate of the isocyanate group was confirmed by FT-IR, until a desired remaining rate was obtained, the reaction was performed at 80° C., so that a reaction liquid was obtained. After the reaction liquid thus obtained was cooled to 40° C., ion exchange water was added, and a potassium hydroxide aqueous solution was added with high speed stirring using a homomixer, so that a liquid was obtained. The liquid thus obtained was heated under reduced pressure to distill off methyl ethyl ketone, so that a water-soluble fixing resin containing an urethane resin at a content (solid content) of 20.0% was obtained.

### Poly(Ethylene Glycol)

PEG1 (n=4 to 9): “Toho Polyethylene Glycol 400”, manufactured by Toho Chemical Industry Co., Ltd.
PEG2 (n=3 to 7): “Toho Polyethylene Glycol 300”, manufactured by Toho Chemical Industry Co., Ltd.
PEG3 (n=3 to 5): “Toho Polyethylene Glycol 200”, manufactured by Toho Chemical Industry Co., Ltd.
PEG4 (n=2): diethylene glycol
PEG5 (n=10 to 15): by fractionation of “Toho Polyethylene Glycol 600”, manufactured by Toho Chemical Industry Co., Ltd., a poly(ethylene glycol) having an n of 10 or more was purified.

### Lactam-Based Compound

ε-caprolactam

### Organic Solvent

Glycerin
Triethylene glycol monobutyl ether

### Surfactant

Acetylene glycol-based surfactant: Olfine E1010 (trade name, acetylene glycol-based surfactant, manufactured by Nisshin Chemical Industry Co., Ltd.)

### 1.2. Evaluation Method of Ink Jet Ink Composition

### 1.2.1. Clogging Recovery Property

After the ink composition prepared as described above was filled in an ink cartridge of a modified machine of LX-10050MF (line ink jet printer manufactured by Seiko Epson Corporation), a test pattern was recorded on a recording medium (A4-size Xerox P paper, copy paper manufactured by Fuji Xerox Co., Ltd., basis weight: 64 g/m2, paper thickness: 88 μm) under pattern conditions in which an adhesion amount was 6 ng/dpi and a resolution was 600×1,200 dpi. After all nozzles were confirmed to be able to eject the ink, while an ink jet head is placed at a position shifted from the position of a cap provided in the printer and is not capped, the ink jet head was left for one day in an environment at a temperature of 35° C. After the head was left as described above, a suction operation of the ink in the nozzle was performed once as a cleaning of the ink jet head, and the number of ejection failure nozzles which were not able to eject the ink was counted. In addition, by the following evaluation criteria, the clogging recovery property was evaluated. The evaluation results are shown in Tables 1 to 2.

### Evaluation Criteria

A: No ejection failure nozzles are observed.
B: Rate of ejection failure nozzles to total nozzles is 1% or less.
C: Rate of ejection failure nozzles to total nozzles is more than 1% to 3%.
D: Rate of ejection failure nozzles to total nozzles is more than 3%.

### 1.2.2. Intermittent Property

Under the pattern conditions described above, recording was continuously performed for 6 hours, and the nozzles were inspected every hour and at the end of the recording to confirm whether or not an ejection failure nozzle was present. When no ink ejection, flight bending after the ink ejection, and/or the like was observed once, this phenomenon was regarded as the ejection failure, and the intermittent property was evaluated by the following evaluation criteria. The results are shown in Tables 1 to 2.

### Evaluation Criteria

A: No ejection failure nozzles are observed.
B: Rate of ejection failure nozzles to total nozzles is 1% or less.
C: Rate of ejection failure nozzles to total nozzles is more than 1%.

### 1.2.3. Image (OD Value)

An image (OD value) of the test pattern of the recorded matter obtained as described above was measured by a colorimeter (Xrite i1, manufactured by Xrite), and the image (OD value) was evaluated by the following evaluation criteria. The evaluation results are shown in Tables 1 to 2.

### Evaluation Criteria

A: OD value is 1 or more.
B: OD value is 0.95 to less than 1.
C: OD value is less than 0.95.

### 1.2.4. Stacking Property

Recording was continuously performed on 20 sheets of the recording media described above, and the stacking property of recorded matters continuously discharged to a discharge portion of an ink jet recording apparatus was evaluated by the following evaluation criteria. The evaluation results are shown in Tables 1 to 2.

### Evaluation Criteria

A: 20 sheets of recorded matters are all received in discharge tray, and edges of recorded matters are aligned so as to be stapled by stapler.
B: Although 20 sheets of recorded matters are all received in discharge tray, edges of recorded matters are shifted and not aligned.
C: 20 sheets of recorded matters are all out of discharge tray, that is, are not received therein.

### 1.2.5. Line-Marker Resistance

On the test pattern of the recorded matter obtained as described above, marking was performed by a line marker (fluorescent pen “OPTEX CARE WKCR1-Y (yellow)” manufactured by ZEBRA Co., Ltd.), and a line-marker resistance was evaluated by the following evaluation criteria. The results are shown in Tables 1 to 2.

### Evaluation Criteria

A: Even when printed portion is painted by line marker, no bleeding occurs.
B: When printed portion is painted by line marker, slight bleeding is observed.
C: When printed portion is painted by line marker, apparent bleeding is observed.

### 2. Evaluation of Ink Set

### 2.1. Preparation of Ink Set

The above ink 1 and the above ink 9 were used in combination as shown in Table 3, so that an ink set 1 was prepared.

Subsequently, the above ink 1 and an ink jet ink composition (hereinafter, referred to as “ink 9-2) which was obtained by removing the poly(ethylene glycol) from the above ink 9 were used in combination as shown in Table 3, so that an ink set 2 was prepared.

TABLE 3

| | | EXAMPLE | | | |
|---|---|---|---|---|---|
| | | INK SET 1 | | INK SET 2 | |
| | | INK | INK | INK | INK |
| INK JET INK COMPOSITION | | 1 | 9 | 1 | 9-2 |
| EVALUATION | LONG-TERM | A | A | B | C |
| RESULT | EJECTION | | | | |
| | STABILITY | | | | |
| | CLOGGING | A | A | A | A |
| | RECOVERY | | | | |
| | PROPERTY | | | | |

### 2.2. Evaluation Method of Ink Set

The ink sets thus prepared were each filled in an ink cartridge of a modified machine of LX-10050MF (line ink jet printer) manufactured by Seiko Epson Corporation so that the two ink compositions of the ink set were configured to be ejected from nozzle lines adjacent to each other.

### Clogging Recovery Property

By the recording apparatus described above, one of the two ink compositions or the other ink composition was only used, and each ink composition was evaluated in a manner similar to that of the clogging recovery property described above.

### Long-Term Ejection Stability

A test pattern was recorded by the recording apparatus described above simultaneously using the two inks. The two inks were adhered in the test pattern under adhesion conditions in which an adhesion amount per one ink was 6 ng/dpi and a recording resolution of 300×600 dpi. The test pattern was continuously recorded for 10 hours on recording media (A4-size Xerox P paper, copy paper manufactured by Fuji Xerox Co., Ltd., basis weight: 64 g/m2, paper thickness: 88 μm).

A nozzle cleaning to wipe a nozzle surface by a wiper was performed every hour during the recording and at the end of the continuous recording. After the recording, the nozzles were inspected to confirm whether or not an ejection failure nozzle was present. When no ink ejection, flight bending after the ink ejection, and/or the like was observed once, this phenomenon was regarded as the ejection failure, and the long-term ejection stability of the nozzle to eject each ink composition was evaluated by the following evaluation criteria. The evaluation results are shown in Table 3.
A: No ejection failure nozzles are observed.
B: Rate of ejection failure nozzles to total nozzles is 1% or less.
C: Rate of ejection failure nozzles to total nozzles is more than 1%.

### 3. Evaluation Result

According to the comparison between the inks 1 to 20 of Examples and the inks H1 to H4 of Comparative Examples, it is found that the ink compositions according to this embodiment are excellent in clogging recovery property, intermittent property, stacking property, and the like as compared to those of the inks H1 to H4 of Comparative Examples in each of which the constituent elements of the ink composition are not satisfied.

From the evaluation of the ink set, it is found that when the ink 9-2 which contains neither two different types of metal ions nor specific poly(ethylene glycol) is used for recording with the ink 1 as a set, the long-term ejection stability is inferior. In addition, after the long-term ejection stability test is performed on the ink 9-2, the generation of the foreign material is observed around the nozzle. On the other hand, when the ink 9 which does not contain two different types of metal ions but contains the specific poly(ethylene glycol) is used for recording with the ink 1 as a set, the long-term ejection stability is superior.

What is claimed is:

1. An ink jet ink composition which is a water-based ink, comprising:
a self-dispersible pigment;
inorganic oxide particles; and
a poly(ethylene glycol) represented by the following general formula (I),
wherein the ink composition contains at least one type of metal ion selected from the group consisting of a potassium ion, a sodium ion, and a lithium ion,
HO—(CH₂—CH₂—O—)ₙ—H (I)
where n represents an integer of 3 to 9.

2. The ink jet ink composition according to claim 1,
wherein the ink composition contains at least two types of metal ions selected from the group consisting of a potassium ion, a sodium ion, and a lithium ion.

3. The ink jet ink composition according to claim 1,
wherein the ink composition is used for recording with at least one another water-based ink jet ink composition, and
the another ink jet ink composition contains a metal ion which is at least one selected from the group consisting of a potassium ion, a sodium ion, and a lithium ion and which is different from the metal ion contained in the ink jet ink composition.

4. The ink jet ink composition according to claim 1,
wherein the metal ion includes a potassium ion, and
the n of the poly(ethylene glycol) is 4 to 9.

5. The ink jet ink composition according to claim 1,
wherein the metal ion includes a sodium ion, and
the n of the poly(ethylene glycol) is 3 to 9.

6. The ink jet ink composition according to claim 1,
wherein the metal ion includes a lithium ion, and
the n of the poly(ethylene glycol) is 3 to 9.

7. The ink jet ink composition according to claim 1,
wherein a content of the poly(ethylene glycol) with respect to a total mass of the ink jet ink composition is 1.0 to 5.0 percent by mass.

8. The ink jet ink composition according to claim 1,
wherein the self-dispersible pigment has a volume average particle diameter D₅₀ of 40 to 250 nm.

9. The ink jet ink composition according to claim 1,
wherein a content of the inorganic oxide particles with respect to a total mass of the ink jet ink composition is 0.5 to 8.0 percent by mass.

10. The ink jet ink composition according to claim 1,
wherein the inorganic oxide particles have a volume average particle diameter D₅₀ is 100 nm or less.

11. The ink jet ink composition according to claim 1,
wherein the self-dispersible pigment includes at least one selected from the group consisting of a carbon black and an organic pigment.

12. The ink jet ink composition according to claim 1,
wherein the inorganic oxide particles includes at least one selected from the group consisting of silica, alumina, zirconia, titania, and ceria.

13. The ink jet ink composition according to claim 1, further comprising a water-soluble fixing resin.

14. The ink jet ink composition according to claim 1,
wherein a content of the self-dispersible pigment with respect to a total mass of the ink jet ink composition is 1.0 to 10 percent by mass.

15. An ink set comprising:
a first ink composition which is the ink jet ink composition according to claim 1; and
a second ink composition which is a water-based ink jet ink composition.

16. The ink set according to claim 15,
wherein the second ink composition contains a metal ion which is at least one selected from the group consisting of a potassium ion, a sodium ion, and a lithium ion and which is different from the metal ion contained in the first ink composition.

17. A recording method comprising:
an ejection step of ejecting the ink jet ink composition according to claim 1 from an ink jet head so as to be adhered to a recording medium.
